(19) United States
(12) Patent Application Publication
(10) Pub. No.: US 2026/0155281 A1
(43) Pub. Date: Jun. 4, 2026

(54) MANUFACTURING APPARATUS FOR ENAMELED WIRE AND MANUFACTURING METHOD FOR ENAMELED WIRE

(71) Applicant: Proterial, Ltd., Tokyo (JP)

(72) Inventors: Hideyuki SUZUKI, Tokyo (JP); Akira SETOGAWA, Tokyo (JP); Kazuya JINUSHI, Tokyo (JP); Masanori SUZUKI, Tokyo (JP); Aika SHIMIZU, Tokyo (JP)

(21) Appl. No.: 19/324,735

(22) Filed: Sep. 10, 2025

(30) Foreign Application Priority Data
Dec. 3, 2024 (JP) 2024-210163

(51) Int. Cl. H01B 13/00; G01H 1/00; H01B 13/06

(52) U.S. Cl. CPC H01B 13/0003; G01H 1/00; H01B 13/0036; H01B 13/065

(57) ABSTRACT

A manufacturing apparatus for an enameled wire includes a mechanism configured to pass a conductor through a wire drawing die, a vibration sensor installed on the wire drawing die or a component fixed to the wire drawing die, and a changer configured to change at least one of a position or an orientation of the wire drawing die.

### CROSS-REFERENCE TO RELATED APPLICATIONS

This application claims the benefit of Japanese Patent Application No. 2024-210163 filed on Dec. 3, 2024 with the Japan Patent Office, the entire disclosure of Japanese Patent Application No. 2024-210163 is incorporated herein by reference.

### BACKGROUND

The present disclosure relates to a manufacturing apparatus for an enameled wire and a manufacturing method for an enameled wire.

The enameled wire includes a conductor and an enamel coating. The conductor is mainly made of copper. The enamel coating covers a surface of the conductor. Japanese Unexamined Patent Application Publication No. 2015-36149 describes a manufacturing method for an enameled wire. In the manufacturing method for the enameled wire, a thick conductor having a circular cross section is repeatedly subjected to wire drawing and annealing to be processed into a conductor having a circular cross section with a desired diameter or a conductor having a rectangular cross section with desired longitudinal and lateral sizes. Then, a coating material is applied to the surface of the conductor to form a coating material film. The coating material contains polyimide or polyamideimide. Then, the coating material film is baked to form the enamel coating.

### SUMMARY

During the wire drawing, the surface of the conductor may be scratched, or fine copper powder may adhere to the surface of the conductor. If there is a scratch or copper powder on the surface of the conductor, problems such as poor appearance, bubbling originating from the scratch, dimensional defect, deterioration in withstand voltage characteristics due to peeling of the conductor, the scratch, a protrusion, and the like, or other errors may easily occur.

In one aspect of the present disclosure, it is preferable to provide a manufacturing apparatus for an enameled wire and a manufacturing method for an enameled wire capable of suppressing scratches to a surface of a conductor or adhesion of fine copper powder to the surface of the conductor during wire drawing.

One aspect of the present disclosure is a manufacturing apparatus for an enameled wire including a mechanism configured to pass a conductor through a wire drawing die. The manufacturing apparatus for the enameled wire includes a vibration sensor installed on the wire drawing die or a component fixed to the wire drawing die, and a changer configured to change at least one of a position or an orientation of the wire drawing die.

The manufacturing apparatus for the enameled wire according to one aspect of the present disclosure can suppress scratches to the surface of the conductor or adhesion of fine copper powder to the surface of the conductor during wire drawing.

Another aspect of the present disclosure is a manufacturing method for an enameled wire including passing the conductor through the wire drawing die. The manufacturing method for the enameled wire includes changing at least one of the position or the orientation of the wire drawing die based on data from the vibration sensor installed on the wire drawing die or the component fixed to the wire drawing die.

The manufacturing method for the enameled wire according to another aspect of the present disclosure can suppress scratches to the surface of the conductor or adhesion of fine copper powder to the surface of the conductor during wire drawing.

### BRIEF DESCRIPTION OF THE DRAWINGS

An example embodiment of the present disclosure will be described hereinafter with reference to the accompanying drawings, in which:

FIG. 1 is an explanatory diagram showing a configuration of a manufacturing apparatus for an enameled wire;

FIG. 2 is a sectional view showing a cross-sectional shape of a rolled conductor;

FIG. 3 is a sectional view showing a cross-sectional shape of a flat conductor;

FIG. 4 is an explanatory diagram showing a configuration of a flat wire drawing machine;

FIG. 5 is an explanatory diagram showing a display displaying data transmitted from a vibration sensor;

FIG. 6 is an explanatory diagram showing a change in position of a flat wire drawing die in a right direction, a left direction, an up direction, and a down direction;

FIG. 7 is an explanatory diagram showing rotation of the flat wire drawing die about a first rotation axis and a pitch angle;

FIG. 8 is an explanatory diagram showing rotation of the flat wire drawing die about a second rotation axis and a yaw angle; and

FIG. 9 is an explanatory diagram showing rotation of the flat wire drawing die about a third rotation axis and a roll angle.

### DETAILED DESCRIPTION OF EXEMPLARY EMBODIMENTS

### First Embodiment

### 1. Overall Configuration of Manufacturing Apparatus 1 for Enameled Wire

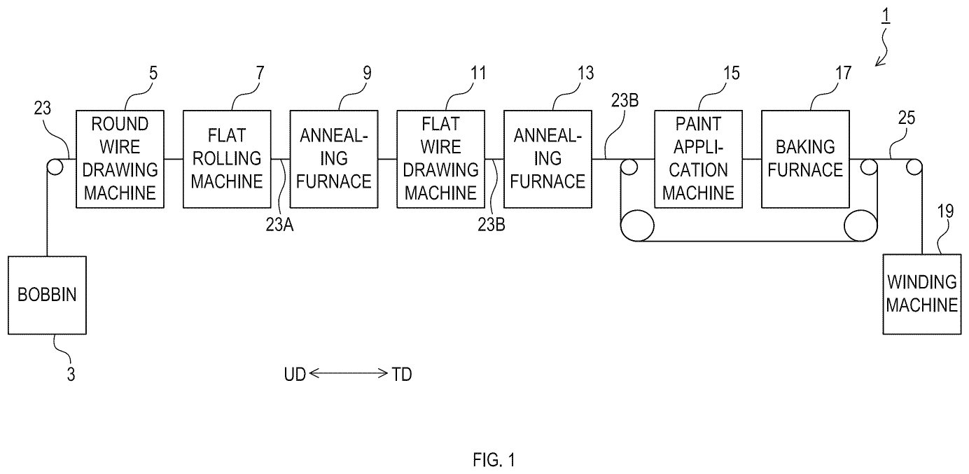

An overall configuration of a manufacturing apparatus 1 for an enameled wire will be described with reference to FIGS. 1 to 3. As shown in FIG. 1, the manufacturing apparatus 1 for the enameled wire includes a bobbin 3, a round wire drawing machine 5, a flat rolling machine 7, an annealing furnace 9, a flat wire drawing machine 11, an annealing furnace 13, a coating material application machine 15, a baking furnace 17, and a winding machine 19. A conductor 23 in the form of a line is wound around the bobbin 3.

When the manufacturing method for the enameled wire is performed using the manufacturing apparatus 1 for the enameled wire, the conductor 23 is drawn out from the bobbin 3, travels along a path passing through the round wire drawing machine 5, the flat rolling machine 7, the annealing furnace 9, the flat wire drawing machine 11, the annealing furnace 13, the coating material application machine 15, and the baking furnace 17 in this order, and is wound up by the winding machine 19. The conductor 23 passes a plurality of times in a section including the coating material application machine 15 and the baking furnace 17.

A material for the conductor 23 is, for example, copper or a copper alloy. A cross-sectional shape of the conductor 23 is circular until a flat rolling to be described below is performed. The cross section of the conductor 23 refers to a section perpendicular to a longitudinal axis of the conductor 23.

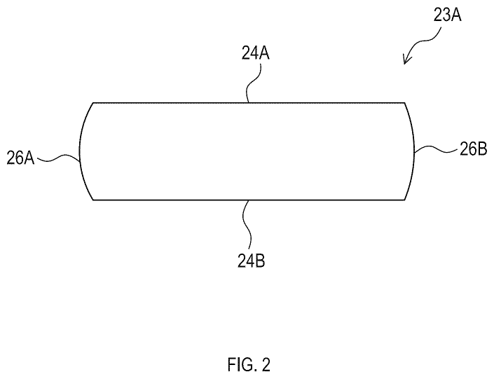

The round wire drawing machine 5 draws the conductor 23 having a circular cross-sectional shape. The flat rolling machine 7 performs the flat rolling on the conductor 23 traveling therethrough. The conductor 23 that has undergone the flat rolling is referred to as a rolled conductor 23A. As shown in FIG. 2, the cross-sectional shape of the rolled conductor 23A is a shape formed by two sides 24A and 24B parallel to each other and two arc-shaped end faces 26A and 26B. In the cross section, the shape of each of the sides 24A and 24B is linear. In the cross section, the length of each of the sides 24A and 24B is longer than the length of each of the end faces 26A and 26B. The annealing furnace 9 anneals the rolled conductor 23A.

The flat wire drawing machine 11 performs a flat wire drawing on the rolled conductor 23A traveling therethrough. The flat wire drawing is a process of drawing the rolled conductor 23A. The conductor 23 that has undergone the flat wire drawing is referred to as a flat conductor 23B. The detailed configuration of the flat wire drawing machine 11 will be described below.

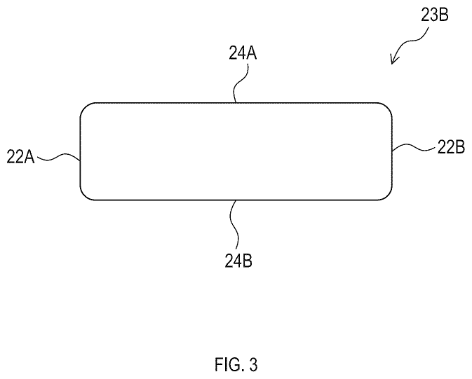

As shown in FIG. 3, the cross-sectional shape of the flat conductor 23B is rectangular. Longer sides of the rectangle are the sides 24A and 24B. Shorter sides 22A and 22B of the rectangle are sides derived from the end faces 26A and 26B, respectively, in the rolled conductor 23A.

As shown in FIG. 1, in the flat wire drawing machine 11, a direction in which the conductor 23 travels is referred to as a traveling direction TD. A direction opposite to the traveling direction TD is referred to as an upstream direction UD. The annealing furnace 13 anneals the flat conductor 23B. The coating material application machine 15 applies an enamel coating material to a surface of the flat conductor 23B to thereby form a film of the enamel coating material of a given thickness on the surface of the flat conductor 23B.

The baking furnace 17 applies heat to the flat conductor 23B traveling therethrough, on which the film of the enamel coating material of the given thickness has been formed by the coating material application machine 15, thus forming a coating. As shown in FIG. 1, the application of the enamel coating material by the coating material application machine 15 and the formation of the coating by the baking furnace 17 are repeatedly performed. This results in manufacturing an enameled wire 25 of a given coating thickness. The enameled wire 25 is wound up by the winding machine 19.

A method for forming a coating is, for example, as follows. The enamel coating material is applied to the surface of the flat conductor 23B. The enamel coating material is a coating material containing, for example, a resin and a solvent. Next, the solvent in the enamel coating material applied to the surface of the flat conductor 23B is evaporated, and the resin in the enamel coating material is cured. After the evaporation of the solvent and the cure of the resin, the enameled wire 25 is formed.

### 2. Configuration of Flat Wire Drawing Machine 11

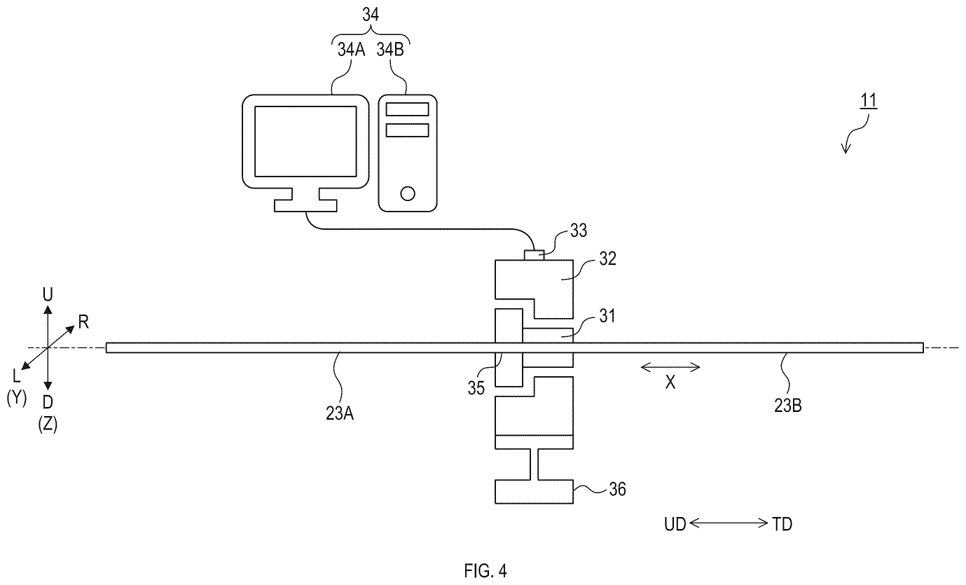

The configuration of the flat wire drawing machine 11 will be described with reference to FIGS. 4 to 9. As shown in FIG. 4, the flat wire drawing machine 11 includes a flat wire drawing die 31, a die holder 32, a vibration sensor 33, a display 34, and a changer 36.

The flat wire drawing die 31 has a processing hole 35 with a rectangular shape. The conductor 23 passes through the processing hole 35 while traveling in the traveling direction TD. The conductor 23 before passing through the processing hole 35 is the rolled conductor 23A. The conductor 23 after passing through the processing hole 35 is the flat conductor 23B.

The flat wire drawing machine 11 corresponds to a mechanism configured to pass the rolled conductor 23A through the flat wire drawing die 31. The step of passing the conductor 23 through the flat wire drawing machine 11 corresponds to a step of passing the rolled conductor 23A through the flat wire drawing die 31.

The die holder 32 holds the flat wire drawing die 31. The die holder 32 corresponds to a component fixed to the flat wire drawing die 31. In the present embodiment, the vibration sensor 33 is installed on the die holder 32. The vibration sensor 33 senses vibrations of the flat wire drawing die 31 and the die holder 32, and transmits data to the display 34. The transmitted data is data representing vibrations of the flat wire drawing die 31 and the die holder 32. A method of transmitting the data may be a wireless method or a wired method.

The vibration sensor 33 senses a vibration on each of the X axis, the Y axis, and the Z axis. Therefore, the vibration sensor 33 senses vibrations on the three axes. The X axis is an axis parallel to an axial direction of the processing hole 35. The Y axis is an axis parallel to a right direction R and a left direction L.

The right direction R is a right direction when the flat wire drawing die 31 is viewed from a viewpoint on the side of the traveling direction TD. The left direction L is a left direction when the flat wire drawing die 31 is viewed from a viewpoint on the side of the traveling direction TD. The right direction R and the left direction L correspond to the horizontal direction. The Z axis is an axis parallel to an up direction U and a down direction D. The up direction U is a vertical and up direction. The down direction D is a direction opposite to the up direction U. The up direction U and the down direction D correspond to the vertical direction.

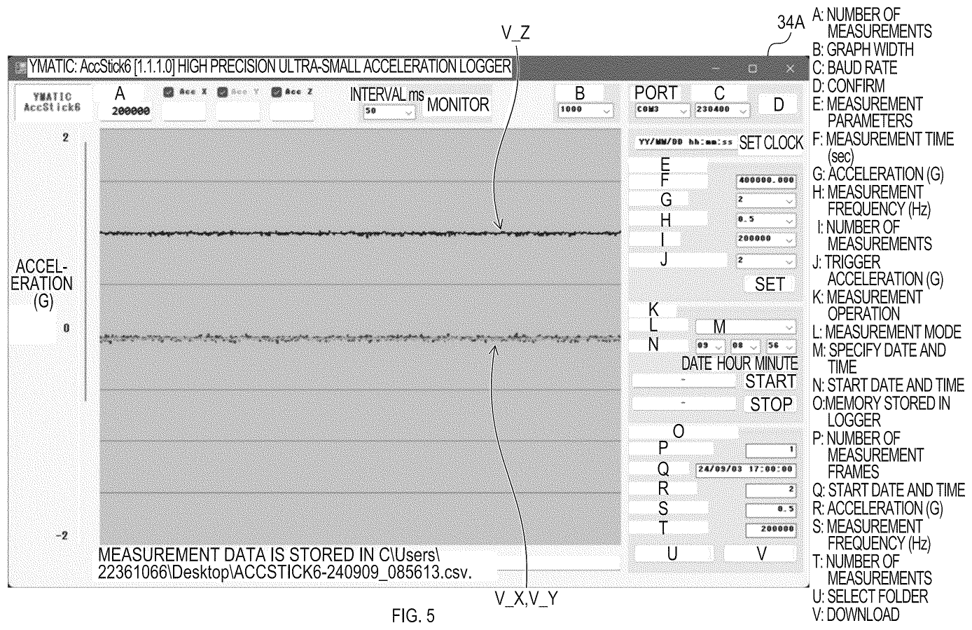

The display 34 displays the data transmitted from the vibration sensor 33. For example, as shown in FIG. 5, the display 34 displays vibration data V_X on the X-axis, vibration data V_Y on the Y-axis, and vibration data V_Z on the Z-axis in the form of a graph. In the graph shown in FIG. 5, the horizontal axis represents time and the vertical axis represents acceleration. As shown in FIG. 4, the display 34 includes a monitor 34A and a computer 34B. The monitor 34A displays the data.

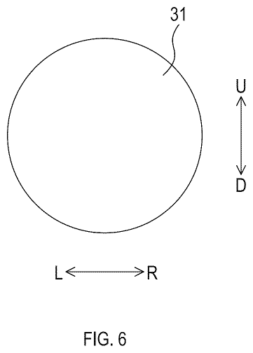

The changer 36 is a mechanism configured to change the position of the flat wire drawing die 31 and the orientation of the flat wire drawing die 31. As shown in FIG. 6, the changer 36 can move the flat wire drawing die 31 in the right direction R or the left direction L to change the position of the flat wire drawing die 31 in the horizontal direction.

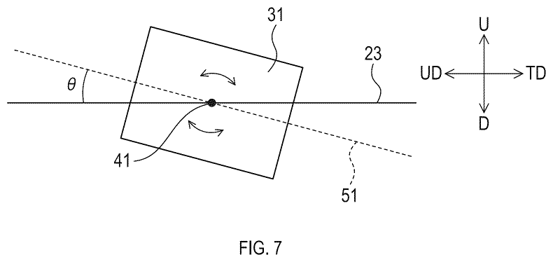

As shown in FIG. 6, the changer 36 can move the flat wire drawing die 31 in the up direction U or the down direction D to change the position of the flat wire drawing die 31 in the vertical direction. As shown in FIG. 7, the changer 36 can rotate the flat wire drawing die 31 about a first rotation axis 41 to change the orientation of the flat wire drawing die 31. The first rotation axis 41 is parallel to the right direction R and the left direction L. When viewed from a viewpoint in the left direction L, the first rotation axis 41 is at the center of the flat wire drawing die 31 and at a position coinciding with the processing hole 35.

When the flat wire drawing die 31 rotates about the first rotation axis 41, a pitch angle θ changes. The pitch angle θ is an angle formed by a first reference line 51 fixed with respect to the flat wire drawing die 31 and the conductor 23 when viewed from the viewpoint in the left direction L. The first reference line 51 is parallel to the axial direction of the processing hole 35.

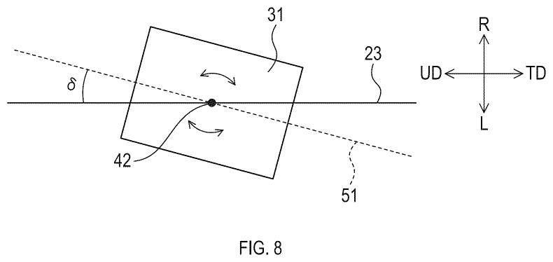

As shown in FIG. 8, the changer 36 can rotate the flat wire drawing die 31 about a second rotation axis 42 to change the orientation of the flat wire drawing die 31. The second rotation axis 42 is parallel to the up direction U and the down direction D. When viewed from a viewpoint in the up direction U, the second rotation axis 42 is at the center of the flat wire drawing die 31 and at a position coinciding with the processing hole 35.

When the flat wire drawing die 31 rotates about the second rotation axis 42, a yaw angle δ changes. The yaw angle δ is an angle formed by the first reference line 51 fixed with respect to the flat wire drawing die 31 and the conductor 23 when viewed from the viewpoint in the up direction U.

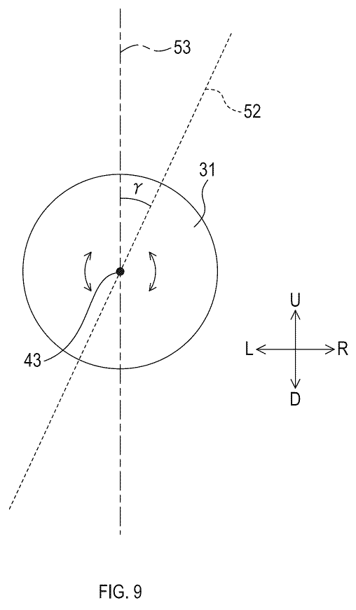

As shown in FIG. 9, the changer 36 can rotate the flat wire drawing die 31 about a third rotation axis 43 to change the orientation of the flat wire drawing die 31. The third rotation axis 43 is parallel to the axial direction of the processing hole 35. The third rotation axis 43 is at a position coinciding with the processing hole 35 when viewed from a viewpoint in the traveling direction TD.

When the flat wire drawing die 31 rotates about the third rotation axis 43, a roll angle γ changes. The roll angle γ is an angle formed by a second reference line 52 fixed with respect to the flat wire drawing die 31 and a third reference line 53 fixed with respect to the conductor 23 when viewed from the viewpoint in the traveling direction TD. The second reference line 52 has a direction orthogonal to the axial direction of the processing hole 35. The third reference line 53 has a direction orthogonal to the sides 24A and 24B.

### 3. Adjustment of Position and Orientation of Flat Wire Drawing Die 31

When the manufacturing method for the enameled wire is performed, the vibration sensor 33 senses vibrations of the flat wire drawing die 31 and the die holder 32, and transmits data to the display 34. The display 34 displays the data transmitted from the vibration sensor 33. The data displayed on the display 34 represents the magnitude of vibrations of the flat wire drawing die 31 on the X axis, the Y axis, and the Z axis.

An operator or a not-shown controller changes at least one of the position or the orientation of the flat wire drawing die 31 using the changer 36 based on the data displayed on the display 34. For example, the controller controls the changer 36 based on the data from the vibration sensor 33 so as to reduce the vibration of the flat wire drawing die 31. For example, by alternately repeating a step of changing the position or the orientation of the flat wire drawing die 31 by a predetermined amount in a predetermined direction and a step of confirming the data displayed on the display 34, the position and the orientation of the flat wire drawing die 31 are adjusted so as to minimize the vibrations of the flat wire drawing die 31 on the X axis, the Y axis, and the Z axis.

The position and the orientation of the flat wire drawing die 31 may be adjusted before starting the manufacturing method for the enameled wire, or may be adjusted during the execution of the manufacturing method for the enameled wire. For example, during the execution of the manufacturing method for the enameled wire, the position and the orientation of the flat wire drawing die 31 can be periodically and repeatedly adjusted.

### 4. Effects Exerted by Manufacturing Apparatus 1 for Enameled Wire and Manufacturing Method for Enameled Wire

(1A) The vibration of the flat wire drawing die 31 increases when the rolled conductor 23A is in partial contact with the flat wire drawing die 31. In the state of partial contact, the surface of the rolled conductor 23A is easily scratched. In addition, in the state of partial contact, fine copper powder is generated by wear of the rolled conductor 23A, and easily adheres to the surface of the rolled conductor 23A. The state of partial contact is a state in which a part of the inner surface of the processing hole 35 abuts on the rolled conductor 23A strongly compared to the other part.

By using the manufacturing apparatus 1 for the enameled wire and the manufacturing method for the enameled wire, the position and the orientation of the flat wire drawing die 31 can be adjusted so as to minimize the vibrations of the flat wire drawing die 31 on the X axis, the Y axis, and the Z axis. The state in which the vibration of the flat wire drawing die 31 is small is a state in which the rolled conductor 23A is not in partial contact with the flat wire drawing die 31, and is a state in which scratches are less likely to be made on and fine copper powder is less likely to adhere to the surface of the rolled conductor 23A.

Therefore, by using the manufacturing apparatus 1 for the enameled wire and the manufacturing method for the enameled wire, it is possible to suppress scratches made on or adhesion of fine copper powder to the surface of the rolled conductor 23A.
(1B) The vibration sensor 33 can sense vibrations on the three axes. By using the manufacturing apparatus 1 for the enameled wire and the manufacturing method for the enameled wire, the position and the orientation of the flat wire drawing die 31 can be adjusted so as to minimize the vibrations on the three axes. As a result, it is possible to further suppress scratches made on or adhesion of fine copper powder to the surface of the rolled conductor 23A.
(1C) By using the manufacturing apparatus 1 for the enameled wire and the manufacturing method for the enameled wire, the position in the horizontal direction, the position in the vertical direction, the pitch angle θ, the yaw angle δ, and the roll angle γ of the flat wire drawing die 31 can be changed. Therefore, the vibration of the flat wire drawing die 31 can be further reduced. As a result, it is possible to further suppress scratches made on or adhesion of fine copper powder to the surface of the rolled conductor 23A.
(1D) As described above, by using the manufacturing apparatus 1 for the enameled wire and the manufacturing method for the enameled wire, the position and the orientation of the flat wire drawing die 31 can be adjusted so as to minimize the vibrations of the flat wire drawing die 31 on the X axis, the Y axis, and the Z axis. The state in which the vibration of the flat wire drawing die 31 is small is a state in which the rolled conductor 23A is not in partial contact with the flat wire drawing die 31, and is a state in which the wear of the flat wire drawing die 31 uniformly progresses.

Therefore, by using the manufacturing apparatus 1 for the enameled wire and the manufacturing method for the enameled wire, the life of the flat wire drawing die 31 can be extended, and reprocessing the flat wire drawing die 31 can be facilitated.

### Other Embodiments

Although the embodiments of the present disclosure have been described so far, the present disclosure is not limited to the above-described embodiments and can be carried out in variously modified forms.
(1) The vibration sensor 33 may be installed on the flat wire drawing die 31.
(2) The changer 36 may change only one of the position and the orientation of the flat wire drawing die 31. The changer 36 may be configured not to change some of the position in the horizontal direction, the position in the vertical direction, the pitch angle θ, the yaw angle δ, and the roll angle γ of the flat wire drawing die 31.
(3) The display 34 may display a synthesized vibration wave of vibrations on two or more axes. In this case, the user can understand the magnitude of the total vibration on the two axes. The display 34 displays, for example, a synthesized vibration wave of the vibrations on two axes. The display 34 displays, for example, a synthesized vibration wave of the vibrations on three axes.
(4) The conductor 23 to be drawn by the flat wire drawing die 31 may be a round wire. In this case, the changer 36 may be configured not to change the roll angle γ.
(5) The directions of the X axis, the Y axis, and the Z axis may be different from those in the first embodiment as long as the directions are orthogonal to one another.
(6) The component on which the vibration sensor 33 is installed may be a component that is different from the die holder 32 and is fixed to the flat wire drawing die 31.
(7) The vibration sensor 33 may sense a vibration on one axis. The one axis is, for example, any of the X axis, the Y axis, and the Z axis. The vibration sensor 33 may be configured to sense vibrations on two axes. The two axes are, for example, the X axis and the Y axis, the Y axis and the Z axis, or the Z axis and the X axis.
(8) The method by which the display 34 displays data may be a method different from that in the first embodiment. For example, the magnitude or the acceleration of the vibration can be indicated by digits. In addition, it is possible to display a figure or the like the size or the length of which changes according to the magnitude or the acceleration of the vibration.
(9) The direction in which the changer 36 moves the flat wire drawing die 31 may be neither the horizontal direction nor the vertical direction. The directions of the first rotation axis 41, the second rotation axis 42, and the third rotation axis 43 may be different from those in the first embodiment.
(10) The flat wire drawing machine 11 need not include the display 34. In this case, for example, the not-shown controller controls the changer 36 based on the data from the vibration sensor 33 to change at least one of the position or the orientation of the flat wire drawing die 31 so as to reduce the vibration of the flat wire drawing die 31.
(11) Function/functions of a single element in each embodiment described above may be performed by two or more elements in a shared manner, and function/functions of two or more elements may be performed by a single element. Part of the configuration in each embodiment described above may be omitted. At least a part of the configuration in each embodiment described above may be added to or replace the configuration in another embodiment described above.
(12) In addition to the manufacturing apparatus 1 for the enameled wire described above, the present disclosure can be implemented in various forms such as a system including the manufacturing apparatus 1 for the enameled wire as an element, a vibration sensing method, a vibration display method, and a method of adjusting a position and an orientation of the wire drawing die.

### Technical Idea Disclosed in the Present Specification

### Item 1

A manufacturing apparatus for an enameled wire, the manufacturing apparatus including:
a mechanism configured to pass a conductor through a wire drawing die;
a vibration sensor installed on the wire drawing die or a component fixed to the wire drawing die; and
a changer configured to change at least one of a position or an orientation of the wire drawing die.

### Item 2

The manufacturing apparatus for the enameled wire described in item 1, wherein
the vibration sensor is configured to sense a vibration on one axis, vibrations on two axes, or vibrations on three axes.

### Item 3

The manufacturing apparatus for the enameled wire described in item 1 or 2, further including
a display configured to display data from the vibration sensor.

### Item 4

The manufacturing apparatus for the enameled wire described in item 3, wherein
the display is configured to display a synthesized vibration wave of vibrations on two or more axes.

### Item 5

The manufacturing apparatus for the enameled wire described in any one of items 1 to 4, wherein
the changer is configured to change one or more of a position in a horizontal direction, a position in a vertical direction, a pitch angle, a yaw angle, and a roll angle of the wire drawing die.

### Item 6

The manufacturing apparatus for the enameled wire described in any one of items 1 to 5, further including
a controller configured to control the changer based on data from the vibration sensor so as to reduce a vibration of the wire drawing die.

### Item 7

A manufacturing method for an enameled wire, the manufacturing method including the steps of:
passing a conductor through a wire drawing die; and
changing at least one of a position or an orientation of the wire drawing die based on data from a vibration sensor installed on the wire drawing die or a component fixed to the wire drawing die.

### Item 8

The manufacturing method for the enameled wire described in item 7, further including the step of displaying the data.

### Item 9

The manufacturing method for the enameled wire described in item 7 or 8, wherein the changing step includes changing at least one of the position or the orientation of the wire drawing die based on the data from the vibration sensor so as to reduce a vibration of the wire drawing die.

What is claimed is:

1. A manufacturing apparatus for an enameled wire, the manufacturing apparatus comprising:
a mechanism configured to pass a conductor through a wire drawing die;
a vibration sensor installed on the wire drawing die or a component fixed to the wire drawing die; and
a changer configured to change at least one of a position or an orientation of the wire drawing die.

2. The manufacturing apparatus for the enameled wire according to claim 1, wherein
the vibration sensor is configured to sense a vibration on one axis, vibrations on two axes, or vibrations on three axes.

3. The manufacturing apparatus for the enameled wire according to claim 1, further comprising
a display configured to display data from the vibration sensor.

4. The manufacturing apparatus for the enameled wire according to claim 3, wherein
the display is configured to display a synthesized vibration wave of vibrations on two or more axes.

5. The manufacturing apparatus for the enameled wire according to claim 1, wherein
the changer is configured to change one or more of a position in a horizontal direction, a position in a vertical direction, a pitch angle, a yaw angle, and a roll angle of the wire drawing die.

6. The manufacturing apparatus for the enameled wire according to claim 1, further comprising
a controller configured to control the changer based on data from the vibration sensor so as to reduce a vibration of the wire drawing die.

7. A manufacturing method for an enameled wire, the manufacturing method comprising the steps of:
passing a conductor through a wire drawing die; and
changing at least one of a position or an orientation of the wire drawing die based on data from a vibration sensor installed on the wire drawing die or a component fixed to the wire drawing die.

8. The manufacturing method for the enameled wire according to claim 7, further comprising the step of displaying the data.

9. The manufacturing method for the enameled wire according to claim 7, wherein the step of changing includes changing at least one of the position or the orientation of the wire drawing die based on the data from the vibration sensor so as to reduce a vibration of the wire drawing die.
